(19) United States
(12) Patent Application Publication
(10) Pub. No.: US 2024/0362534 A1
(43) Pub. Date: Oct. 31, 2024

(54) METHOD FOR OUTLIER ROBUST SUBGROUP INFERENCE VIA CLUSTERING IN THE GRADIENT SPACE

(71) Applicants: INTERNATIONAL BUSINESS MACHINES CORPORATION, ARMONK, NY (US); MASSACHUSETTS INSTITUTE OF TECHNOLOGY, CAMBRIDGE, MA (US)

(72) Inventors: Kristjan Herbert Greenewald, Belmont, MA (US); Luann Jung, Queens, NY (US); Justin Solomon, Somerville, MA (US); Mikhail Yurochkin, Cambridge, MA (US); Yuchen Zeng, Madison, WI (US)

(21) Appl. No.: 18/309,755

(22) Filed: Apr. 28, 2023

(51) Int. Cl. G06N 20/00

(52) U.S. Cl. CPC G06N 20/00

(57) ABSTRACT

A computer-implemented method for identifying relevant subgroups, which are relevant for training a subgroup-robust classifier, in a training dataset associated with a machine learning model includes receiving a classification dataset wherein subgroups are unlabeled. For each data point in the classification dataset, the method uses gradient space partitioning (GraSP) to identify a gradient representation of each data point by extracting an associated gradient of a logistic regression classification loss with respect to weights of a logistic regression. The gradient representations are clustered to provide estimated subgroup labels the cluster assignments are output as the estimated subgroup labels.

### BACKGROUND

### Technical Field

The present disclosure generally relates to machine learning methods, and more particularly, to a computer-implemented method, a computer system, and a computer program product for identifying relevant subgroups in the training data by doing outlier-aware clustering in the gradient space.

### Description of the Related Art

While traditional machine learning (MIL) focuses on optimizing performance averaged over an entire training dataset, training classifiers to have robust performance on small subgroups is often useful for creating models that will be used in the real world. Two issues may arise in training data. First, with a distribution shift issue, the training data may under-represent subgroups that are over-represented at test time, leading to loss of performance if the model is not robust. Second, with a fairness issue, not all protected human groups are equally represented in most training sets, yet it is fundamental to fairness that the learned classifier performs equally well on them.

If the identity of these subgroups is identified in the training data beforehand, robust distributionally robust optimization (DRO) can be used to optimize worst-subgroup performance. However, it is often the case that these subgroups are not labeled in the data, or possibly, the identity of the subgroups may not even be known.

### SUMMARY

In one embodiment, a computer-implemented method for identifying relevant subgroups in a training dataset associated with a machine learning model includes receiving a classification dataset, wherein subgroups are unlabeled. For each data point in the classification dataset, the method uses gradient space partitioning (GraSP) to identify a gradient representation of each data point by extracting an associated gradient of a logistic regression classification loss with respect to weights of a logistic regression. The gradient representations are clustered to provide estimated subgroup labels. The cluster assignments are output as the estimated subgroup labels.

The above method can be performed on non-transitory computer readable storage medium tangibly embodying a computer readable program code having computer readable instructions that, when executed, causes a computer device to identify relevant subgroups in a training dataset associated with a machine learning model.

In some embodiments, classes are labeled in the classification dataset, while the subclasses are unlabeled.

In some embodiments, the method further includes training a robust classifier using the estimated subgroup labels. In some embodiments, a distributionally robust optimization (DRO) is applied to train the robust classifier.

In some embodiments, in response to receiving the classification dataset, the method further includes applying a non-robust neural network classifier, wherein a last layer representation of the non-robust neural network classifier is extracted as dimension-reduced features. In some embodiments, the gradient space partitioning is performed on the last-layer representation.

In one embodiment, a computer-implemented method for identifying relevant subgroups, in the presence of outliers, for training a classifier to be robust to the identified subgroups, includes receiving a classification dataset, wherein subgroups are unlabeled. For each data point in the classification dataset, gradient space partitioning (GraSP) can be used to identify a gradient representation of each data point by extracting an associated gradient of a logistic regression classification loss with respect to weights of a logistic regression. The GraSP can further learn group annotations and identify outliers. The gradient representations can be clustered to estimate subgroup labels. The clustering further comprises using an outlier-robust clustering algorithm to cluster the gradient representations. The cluster assignments can be output as the estimated subgroup labels and a robust classifier can be trained using the estimated subgroup labels.

By virtue of the concepts discussed herein, systems and methods are provided for identifying relevant subgroups in the training data by doing outlier-aware clustering in the gradient space. Aspects of the present disclosure can reduce the time and computing resources involved in training classifiers to have robust performance on small subgroups.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A illustrates a dataset in two dimensions, where there are four groups g=1, 2, 3, 4 and an outlier, where g=1 and g=3 are the majority groups distributed as mixtures of three components each; g=2 and g=4 are unimodal minority groups and the y-axis is the decision boundary of a logistic regression classifier;

FIG. 1B illustrates a data view for learning group annotations and detecting outliers via clustering of samples with y=0, showing how loss values can confuse outliers and minority samples which both can have high loss;

FIG. 1C illustrates a data view for learning group annotations and detecting outliers via clustering of samples with y=0, showing how, in the original feature space, it is difficult to distinguish one of the majority group modes and the minority group;

FIG. 1D illustrates a data view for learning group annotations and detecting outliers via clustering of samples with y=0, showing how gradient space simplifies the data structure making it easier to identify the minority group and to detect outliers, consistent with an illustrative embodiment;

FIGS. 2A and 2B show normalized representations of the data from FIG. 1A, where FIG. 2A shows the representation in a feature space and FIG. 2B shows the representation in a gradient space; and

FIG. 3 is a functional block diagram illustration of a computer hardware platform that can be used to implement the method for identifying relevant subgroups in a training dataset associated with a machine learning model, according to an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

Empirical Risk Minimization (ERM), i.e., the minimization of average training loss over the set of model parameters, is the standard training procedure in machine learning. It yields models with strong in-distribution performance but does not guarantee satisfactory performance on minority groups that contribute relatively few data points to the training loss function. This effect is particularly problematic when the minority groups correspond to socially-protected groups. For example, in the toxic text classification task, certain identities are overwhelmingly abused in online conversations that form data for training models detecting toxicity. Such data lacks sufficient non-toxic examples mentioning these identities, yielding problematic and unfair spurious correlations—as a result ERM learns to associate these identities with toxicity. A related phenomenon is subpopulation shift, i.e., when the test distribution differs from the train distribution in terms of group proportions. Under subpopulation shift, poor performance on the minority groups in the train data translates into poor overall test distribution performance, where these groups are more prevalent or more heavily weighted. Subpopulation shift occurs in many application domains.

Existing methods can improve the worst-group performance, but they can have several limitations: (i) they require group annotations, which are often expensive and sometimes infeasible to obtain, and/or (ii) they are sensitive to outliers. Most conventional methods fail to solve these two issues simultaneously as they focus on conflicting perspectives of minority groups and outliers.

As discussed in greater detail below, aspects of the present disclosure provide methods to learn group annotations in the presence of outliers. Rather than using loss values (which have been seen to create opposing tradeoffs), aspects of the present disclosure can first represent data using gradients of a datum's loss with respect to the model parameters. Such gradients signify how a specific data point wants the parameters of the model to change to fit it better. In this gradient space, groups can be anticipated (conditioned on label) to correspond to gradients forming clusters. Outliers, on the other hand, majorly correspond to isolated gradients: they are likely to want model parameters to change differently from any of the groups and other outliers.

The gradient space structure allows the separation of the outliers and permits the learning of the group annotations via traditional clustering techniques such as DBSCAN. The learned group annotations can be used to train models with improved worst-group performance (measured with respect to the true group annotations).

Accordingly, as provided in the below further discussion, aspects of the present disclosure show that gradient space simplifies the data structure and makes it less computationally complex to learn group annotations via clustering. Further, aspects of the present disclosure provide a concept called “Gradient Space Partitioning” (GRASP), a method for learning group annotations by a computing device, in the presence of outliers for training models robust to subpopulation shift. Extensive experiments were conducted on one synthetic dataset and three datasets from different modalities to demonstrate that the methods of the present disclosure achieve state-of-the-art performance both in terms of group identification quality and downstream worst-group performance, thereby improving the accuracy of the computing device in determining the classification of subgroups in an unlabeled dataset.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may obviate a need for time consuming data group classification by the user in efforts to develop machine learning classification methods. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

### Preliminary Analysis

One can denote [N]={1, . . . , N} and can consider a dataset [symbol] ={z}ᵢ₌₁ⁿ ⊂Z including n samples z∈Z, z=(x, y), where x∈X= [symbol] ^{d} is the input feature and y∈ [symbol] {1, . . . , C} is the class label. The samples from each class y∈ [symbol] are categorized into K_{y} groups. K can be denoted to be the total number of groups { [symbol] ₁, . . . , [symbol] _{K}}≙P⊂Z, where K= [symbol] K_{y}. The group membership of each point in the dataset can be denoted {gᵢ}ᵢ₌₁ⁿ, where gᵢ∈|K| for all i∈|n|. For example, in toxicity classification, a group could correspond to a toxic comment mentioning a specific identity, or, in image recognition, a group could be an animal species appearing on an atypical background.

The goal is to learn a model h∈H: X→Y parameterized by θ∈Θ that performs well on all groups Gₖ, where k∈[K]. Depending on the application, this model can alleviate fairness concerns, remedy spurious correlations in the data, and promote robustness to subpopulation shift, i.e., when the test data has unknown group proportions.

The approaches for learning in the presence of minority groups can be divided into three categories: the group-aware setting, where the group annotations gᵢ are known, the group-oblivious setting, that does not use the group annotations, and the group-learning setting, where the group annotations are learned from data to be used as inputs to the group-aware methods.

Group-aware setting. Conventional methods assume access to the minority group annotations. Among the conventional methods in this setting is group Distributionally Robust Optimization (gDRO). Let [symbol] : Y×Y be a loss function. The optimization problem of gDRO is

$${min}_{θ ∈ Θ} {max}_{k ∈ \vert K \vert} \frac{1}{{𝒢}_{k}} {\sum }_{z ∈ {𝒢}_{k}} ℓ ( y , {h}_{θ} ( x ) ) , ( gDRO )$$

which aims to minimize the maximum group loss.

Group-oblivious setting. In contrast to the group-aware setting, the group-oblivious setting attempts to improve worst-group performance without group annotations. Methods in this group rely on various forms of DRO or adversarial reweighing. Algorithmically, this results in up/down-weighing the contribution of the high/low-loss points.

Group-learning setting. The final category corresponds to a two-step procedure, wherein the data points are first assigned group annotations based on various criteria, followed by group-aware training typically using gDRO. In this category, “Just Train Twice” (JTT) trains an ERM model and designates high-loss points as the minority and low-loss points as the majority group; “George” seeks to cluster the data to identify groups with a combination of dimensionality reduction, over clustering, and augmenting features with loss values; and Environment Inference for Invariant Learning (EIIL) finds group partition that maximizes the invariant risk criterion.

The method according to aspects of the present disclosure, sometimes referred to herein as Gradient Space Partitioning (GraSP), belongs to the group-learning setting category. GraSP differs from conventional methods in its ability to account for outliers in the data. In addition, conventional methods in this and the group-oblivious categories typically require validation data with true group annotations for model selection to achieve meaningful worst-group performance improvements over ERM, while GraSP does not need these annotations to achieve good performance. In experiments, described in greater detail below, this can be attributed to GraSP's better recovery of the true group annotations, making them suitable for gDRO model selection.

The challenge of outliers. Outliers, e.g., mislabeled samples or corrupted images, are ubiquitous in applications, and outlier detection has long been a topic of inquiry in machine learning. Outliers are especially challenging to detect when data has (unknown) minority groups, which could be hard to distinguish from outliers but require the opposite treatment: Minority groups are upweighted while outliers are discarded.

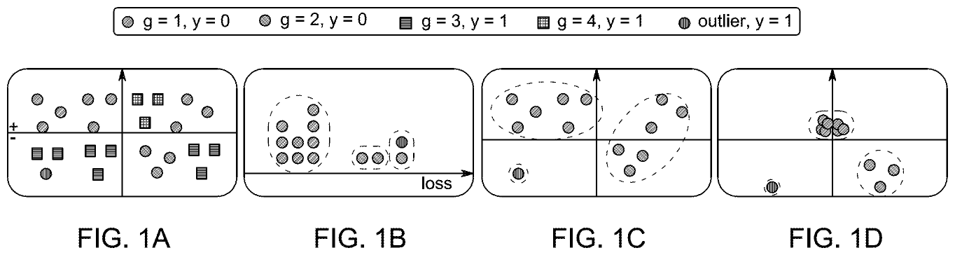

FIGS. 1A through 1D show illustrations of learning group annotations in the presence of outliers, where FIG. 1A illustrates toy dataset in two dimensions, where there are four groups g=1, 2, 3, 4 and an outlier, where g=1 and g=3 are the majority groups distributed as mixtures of three components each; g=2 and g=4 are unimodal minority groups and the y-axis is the decision boundary of a logistic regression classifier, and where FIGS. 1B through 1D compare different data views for learning group annotations and detecting outliers via clustering of samples with y=0, where FIG. 1B shows how loss values can confuse outliers and minority samples which both can have high loss; FIG. 1C shows how, in the original feature space, it is difficult to distinguish one of the majority group modes and the minority group; and FIG. 1D shows how gradient space simplifies the data structure making it easier to identify the minority group and to detect outliers

An illustration of a dataset with minority groups and an outlier is shown in FIG. 1A. FIG. 1B illustrates the problem with methods relying on the loss values. Specifically, conventional methods can upweigh high-loss points, overfitting the outlier. These methods assume that outliers will have higher loss values than the minority group samples, which can easily be violated leading to exclusion of the minority samples.

Gradients as data representations. Given a model h_{θ}_{₀}(⋅) and loss function [symbol] (⋅, ⋅), one can consider an alternative representation of the data where each sample is mapped to the gradient with respect to the model parameters of the loss on this sample:

$$\begin{matrix}{{f}_{i} = \frac{\partial ℓ ( {y}_{i} , {h}_{θ} ( {x}_{i} ) )}{\partial θ} \vert}_{θ = {θ}_{0}} & for i = 1 , … , n .\end{matrix} \qquad ( 1 )$$

Equation 1 is referred to herein as the gradient representation. Aspects of the present disclosure show that, unlike loss values, gradient representations are suitable for simultaneously learning group annotations and detecting outliers. Compared to the original feature space, gradient space simplifies the data structure, making it easier to identify minority groups. FIG. 1C illustrates a failure of feature space clustering. Here the majority group for class y=0 is a mixture of three components with one of the components being close to the minority group in the feature space. In the gradient space, for a logistic regression model, representations of misclassified points remain similar to the original features, while the representations of correctly classified points are pushed towards zero. The benefits of the gradient representations are illustrated in FIG. 1D and additional details are provided below.

### Gradient Spaces as Compared to Feature Space

Logistic regression example. An example is presented based on the logistic regression model to better understand how using the gradient space simplifies the data structure and aids clustering.

Consider a binary classification problem (y∈{0, 1}) and logistic regression model [symbol] (y=1|x)=σ(ω^{T}x+b) trained on the given dataset [symbol] , where α(⋅) denotes the sigmoid function, ω are the coefficients and b is the bias. Recall that the logistic regression loss is

$$ℓ ( y , σ ( {ω}^{T} x + b ) ) = - y log ( σ ( {ω}^{T} x + b ) ) - ( 1 - y ) log ( 1 - ( σ ( {ω}^{T} x + b ) ) .$$

The gradient of this loss at point z with respect to (ω, b) is

$$f = : {∇}_{[ ω , b ]} ℓ ( y , {ω}^{T} x + b ) = ( σ ( {ω}^{T} x + b ) - y ) [ \begin{matrix}x \\ 1\end{matrix} ] . \qquad ( 2 )$$

Note that this gradient is simply a scaling of the data vector x by the error (σ(ω^{T}x+b)−y)∈[−1, 1], padded by an additional element (the bias entry) of the error alone. In particular, note that when z is correctly classified, the scaling (σ(ω^{T}x+b)−y) will be close to zero, and when it is incorrectly classified, the magnitude of the scaling will approach 1.

The gradient of equation 2 can be interpreted through the lens of Euclidean distance (∥fᵢ−fⱼ∥₂) and centered cosine distance (1−( [symbol] fᵢ−μ_{f},fⱼ−μf [symbol] /∥fᵢ−μ_{f}∥₂·∥fⱼ−ρ_{f}∥₂)) metrics, respectively. Recall that clustering can be applied to each class independently. Here f refers to the class-conditional empirical mean of f.

Euclidean distance. The scaling effect mentioned in the previous paragraph shrinks the correctly classified points towards the origin, while leaving the misclassified points almost unaffected. The error itself is included as an extra element. Consequently, gradient clustering with respect to Euclidean distance should cluster the correctly classified samples into one “majority” group, and then divide the remaining points into minority groups and outliers based on the size of the error and their position in the feature space. For a visual example, see FIG. 1D.

Centered cosine distance. The class conditioned centering terms in the gradient and feature spaces, μ_{f} and μₓ respectively are compared:

$${u}_{f} = \frac{1}{n} {\sum }_{i : {y}_{i} = c} ( σ ( {ω}^{T} {x}_{i} + b ) - {y}_{i} ) [ \begin{matrix}{x}_{i} \\ 1\end{matrix} ] , {u}_{x} = \frac{1}{n} {\sum }_{i : {y}_{i} = c} {x}_{i}$$

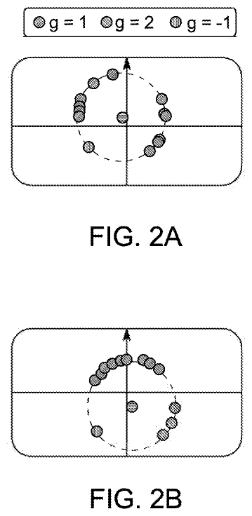

Due to the underrepresentation of the minority group in the data, the feature space center will be heavily biased towards the majority group, which could hinder the clustering as illustrated in FIG. 2A. On the other hand, the expression of f above implies that gradient space center upweighs high-loss points which are more representative of the minority groups, resulting in a center in-between minority and majority groups. Thus, centering in the gradient space facilitates learning group annotations via clustering with the cosine distance as illustrated in FIG. 2B.

Quantitative comparison. The group identification quality of clustering in feature space and gradient space was compared on two datasets including 4 groups. Both clean and contaminated versions were considered. The first dataset is “Synthetic” based on the FIG. 1A illustration. The second dataset is known as “Waterbirds”, which is a semi-synthetic dataset of images of two types of birds placed on two types of backgrounds. The images were embedded with a pre-trained ResNet50 model. To obtain gradient space representations, logistic regression models were trained, as described below.

Three popular clustering methods were considered: K-means, DBSCAN with Euclidean distance, and DBSCAN with centered cosine distance. Group annotations quality is evaluated using the Adjusted Rand Index (ARI), a measure of clustering quality. Higher ARI indicates higher group annotations quality, and ARI=1 implies the predicted group partition is identical to the true group partition. The results are summarized in Table 1, below. Clustering in the gradient space noticeably outperforms clustering in the feature space. These results provide empirical evidence that gradient space facilitates learning of group annotations via clustering.

TABLE 1

| | | Feature Space | | | Gradient Space | | |
|---|---|---|---|---|---|---|---|
| | | K- | DBSCAN/ | DBSCAN/ | K- | DBSCAN/ | DBSCAN/ |
| Dataset | Outliers | means | Euclidian | CoS | means | Euclidian | CoS |
| Synthetic | No | .5505 | .5923 | .5133 | .8409 | .7724 | .6943 |
| | Yes | .3631 | .6042 | .4946 | .6436 | .7237 | .6944 |
| Waterbirds | No | .3932 | .0000 | .0418 | .7235 | .7304 | .7453 |
| | Yes | .3932 | .0000 | .0418 | .7171 | .7304 | .7453 |

Clustering method and distance measure. Results in Table 1 indicate that both K-means and DBSCAN perform well in the gradient space. DBSCAN is a density-based clustering algorithm, where clusters are defined as areas of higher density, while the rest of the data is considered outliers. The experiments described below use DBSCAN for its ability to identify outliers, which is an important aspect of the problem consider herein. As an additional benefit, unlike K-means, DBSCAN does not require knowledge of the number of groups. However, it should be understood that other clustering algorithms, such as K-means, would also prove successful according to illustrative embodiments of the present disclosure, as evidenced by Table 1, above.

In terms of distance measure, cosine distance is recommended due to its better performance on the Waterbirds data, which closer resembles real data. It should be noted that the distance and clustering method choices could be reconsidered depending on the application. For example, for Gaussian-like data without outliers, K-means performed better in Table 1.

GraSP. The pseudocode of GRASP is presented in Algorithm 1, below. In one embodiment an ERM classifier h_{θ}(⋅) is first trained and the gradients of sample's loss with respect to model parameters θ are collected. Then the pairwise centered cosine distances are computed within each class y∈Y using gradient representations, as discussed above. Lastly, to estimate the group annotations and identify outliers, DBSCAN may be applied on these distance matrices for each class y∈Y.

Algorithm 1: GraSP

```
Input : DBSCAN hyperparameters ε and m
Train the ERM classifier θ₀ ← arg min_{θ∈Θ}, [symbol]  (y, h_{θ} (x));
for z ∈ [symbol]  do
    ${Compute its gradient f ← \frac{\partial ℓ ( {y}_{i} , {h}_{θ} ( {x}_{i} ) )}{\partial θ} \vert}_{θ = {θ}_{0}} ;$
for y ∈ Y do
    Consider all samples {zᵢ} ⊂ [symbol]  with y = y and their corresponding gradients {fᵢ} ;
    μ_{f} ← mean ({fᵢ}), compute the distance matrix D, where Dᵢⱼ = 1- ( [symbol] fᵢ−μ_{f} , fⱼ₋μ_{f} [symbol] ) / ||fᵢ-μ_{f}||·
        ||fⱼ-μ_{f}||));
    Assign group annotations and identify outliers by performing DBSCAN clustering in
        gradient space: {gᵢ} ← DBSCAN (D, ε, m), where gᵢ = -1 indicates outliers ;
Output : Dataset with predicted group annotations [symbol] ' ← {(x, ĝ, y) [symbol]  , where the
        detected outliers are removed
```

Training models with improved worst-group performance in the presence of outliers using GRASP. The identified outliers are discarded and then learned group annotations are provided as inputs to a Group-aware method of choice. For concreteness, in the present disclosure, equation gDRO was used. It should be noted that other choices could be appropriate. For example, methods accounting for noise in group annotations are interesting to consider as they could counteract mistakes in GraSP annotations.

### Experiments

In this section, extensive experiments were conducted on both synthetic and benchmark datasets to evaluate the performance of GraSP. The results show that GraSP outperforms the conventional baselines in terms of group identification quality and downstream worst-group performance while providing robustness to outliers.

### A. Datasets and Baselines

Synthetic. A synthetic dataset was generated of 1,000 samples with two features x∈ [symbol] ², a group attribute g∈[4], and a binary label y∈{0, 1}, similar to the motivating example of FIG. 1A. (Clean): The synthetic dataset includes 10 Gaussian clusters with a variance of 0.01, and each Gaussian cluster contains 100 samples. Class 0 is divided into two groups: group 3 includes four Gaussian clusters with centers (1, 5), (1, 3), (1, 2), (1, 1); group 2 includes one Gaussian cluster with center (0, 4). Similarly, Class 1 is divided into two groups: group 1 includes four Gaussian clusters with centers (0, 5), (0, 3), (0, 2), (0, 1); group 2 includes one Gaussian cluster with center (1, 4). (Contaminated): The synthetic dataset was contaminated by flipping randomly selected 5% of labels.

Waterbirds. (Clean): Waterbirds is a semi-synthetic image dataset of land birds and water birds placed on either land or water backgrounds using images from the Places dataset. There are 11,788 images of birds on their typical (majority) and atypical (minority) backgrounds. The task is to predict the types of birds and the background type is the group (2 background types per class, a total of 4 groups). (Contaminated): The Waterbirds dataset was contaminated by introducing outliers in the training and validation datasets. The class labels of 2% of the data was flipped, 1% of the images were transformed with Gaussian blurring, color dither (randomly change the brightness, saturation, and contrast of the images) was performed on 1% of the images, and 1% of the images were posterized, maintaining 4 bits per color channel.

COMPAS & CivilComments. Both datasets are real and collected by humans, therefore likely to contain outliers. COMPAS is a recidivism risk score prediction dataset consisting of 7,214 samples. Each class y∈[0, 1] is divided into six groups: Caucasian males, Caucasian females, African-American males, African-American females, males of other races, and females of other races, making 12 groups in total. CivilComments is a language dataset containing online forum comments. The task is to predict whether comments are toxic or not. The comments were divided in each class into two groups according to the presence or absence of identity terms pertaining to protected groups.

Experimental baselines. GraSP was compared to four different types of baselines: (1) standard empirical risk minimization (ERM), (2) a group-aware method (gDRO), (3) a group-oblivious method (DORO), and (4) two group learning methods (EIIL and George). DORO was chosen among the methods relying on loss values to improve worst-group performance because it is the only method from this group designed to be robust to outliers. Recall that only the group-aware method (gDRO) has access to the true group annotations, thus it should be interpreted as an “oracle” baseline.

An ablation study was also performed by considering an additional group-learning baseline, Feature Space Partitioning (FeaSP). It is identical to GraSP except it performs DBSCAN clustering in the feature space. Comparison to FeaSP emphasizes the importance of clustering in the gradient space as opposed to other choices such as the clustering method and distance measure.

### B. Evaluation of GraSP

The performance of GraSP was assessed in terms of group identification and downstream tasks of training models with comparable performance across groups, both with and without outliers. In all experiments, true group annotations were considered as being unknown in both train and validation data (except for “oracle” gDRO which has access to true group annotations in both train and validation data). Arguably, this setting is more practical due to group annotations often being expensive or infeasible to obtain, even for a smaller validation set.

Group annotations quality. The first experiment examined the quality of group annotations learned with GraSP. To collect the gradients of the data's losses with respect to the model parameters, a logistic regression model was trained on the Synthetic dataset, a three-layer ReLU neural network with 50 hidden neurons per layer on the COMPAS dataset, and a BERT model on the CivilComments dataset (due to the large number of parameters in BERT, only the last transformer and the subsequent prediction layer was considered when extracting gradients). For the Waterbirds dataset, the images were first featurized using a ResNet50 pre-trained on ImageNet, and then a logistic regression was trained. DBSCAN clustering was then used, with centered cosine distance. DBSCAN hyperparameters were selected using standard clustering metrics that do not require knowledge of the true group annotations.

In Table 2, below, group identification quality of GraSP (measured with ARI) is compared to three group learning baselines, EIIL, George, and FeaSP, across four datasets. There are two key observations supporting the methods of the present disclosure: (i) clustering in the gradient space (GraSP) outperforms clustering in the feature space (FeaSP and George), as well as other baselines (EIIL); (ii) GraSP is robust to outliers, i.e., it performs equally well in the presence and absence of outliers. To comment on the low ARI of EIIL, it should be noted that the Invariant Risk criteria EIIL optimizes was designed primarily for invariant learning (i.e., learning environment labels), which may not be suitable for learning group annotations.

TABLE 2

| | Dataset | | | | | |
|---|---|---|---|---|---|---|
| | | | | | | CivilCom- |
| | Synthetic | | Waterbirds | | COMPAS | ments |
| | Outliers | | | | | |
| | No | Yes | No | Yes | n/a | n/a |
| Method | ARI | ARI | ARI | ARI | ARI | ARI |
| EIIL | −.0069 | −.0043 | −0114 | .0078 | −.0025 | −.0001 |
| George | .6027 | .4565 | .2832 | .2600 | .1962 | .1422 |
| FeaSP | .5133 | .4946 | .0418 | .0418 | .2956 | .2093 |
| GraSP | .6943 | .6944 | .7453 | .7453 | .5453 | .2639 |

Worst-group performance. This is the standard metric when comparing methods for training machine learning models with comparable performance across groups (evaluated with respect to true group annotations). For the group-learning methods (GraSP, FeaSP, George, EIIL), identified outliers were first discarded if applicable (GraSP and FeaSP), and then gDRO was used for training with the corresponding learned group annotations. The learned group annotations were also used on the validation data to select the corresponding gDRO hyperparameters. For ERM and DORO, the validation set overall performance was used for hyperparameter selection. For all methods, on a given dataset, models were trained with the same architecture and initialization. Recall that these models can be different from the models used in estimating group annotations with any of the group-learning methods.

Results are summarized in Table 3, below. GraSP outperforms baselines on Synthetic, COMPAS, and Civil-Comments datasets. For the Waterbirds dataset, GraSP also performs relatively well. Interestingly, EIIL performs best on the contaminated Waterbirds dataset, despite the poor ARI discussed earlier. It is, however, failing on the COMPAS dataset. It was also noticed that GraSP outperforms “oracle” gDRO on Synthetic and COMPAS datasets. This could be due to the fact that gradient space clustering helps to focus on “harder” instances, as discussed above, while the available (“oracle”) group annotations (at least on COMPAS), might be noisy.

TABLE 3

| | Synthetic | | Waterbirds | | Compas | Civil |
|---|---|---|---|---|---|---|
| | Outliers | | | | | |
| | No | Yes | No | Yes | | Comments |
| Method | Worst(Avg) | Worst(Avg) | Worst(Avg) | Worst(Avg) | .Worst(Avg) | Worst(Avg) |
| ERM | .6667(.8823) | .5333(.8273) | .6075(.9673) | .5249(.9621) | .4706(.6792) | .4659(.9213) |
| DORO | .6667(.8823) | .6000(.8342) | .5888(.9694) | .6636(.9686) | .4706(.6801) | .4905(.9182) |
| EIIL | .6667(.8783) | .6000(.8115) | .6916(.9645) | .7056(.9629) | .0588(.6046) | .6056(.9066) |
| George | .5333(.8732) | .6000(.8342) | .7523(.9612) | .5897(.9100) | .4416(.6232) | .5897(.9100) |
| FeaSP | .6667(.8823) | .6667(.8823) | .1417(.9646) | .1417(.9346) | .4416(.6232) | .6056(.9066) |
| GraSP | .8000(.8926) | .8000(.8926) | .6854(.9654) | .6798(.9004) | .4743(.6717) | .6798(.9004) |
| gDRO | .7333(.8639) | .8000(.8755) | .8665(.9272) | .8545(.9081) | .4625(.6807) | .6941(.8767) |

### Conclusions

Aspects of the present disclosure focus on the problem of learning group annotations in the presence of outliers. The methods of the present disclosure allow training models with comparable performance across groups to alleviate spurious correlations and accommodate subpopulation shifts when group annotations are not available and need to be estimated from data. This was accomplished by leveraging existing outlier-robust clustering approaches to estimate the group (and outlier) memberships of each point in the dataset. Aspects of the present disclosure provide an approach where the clustering is performed in the gradient space, where the gradient is of the loss at each point with respect to model parameters.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

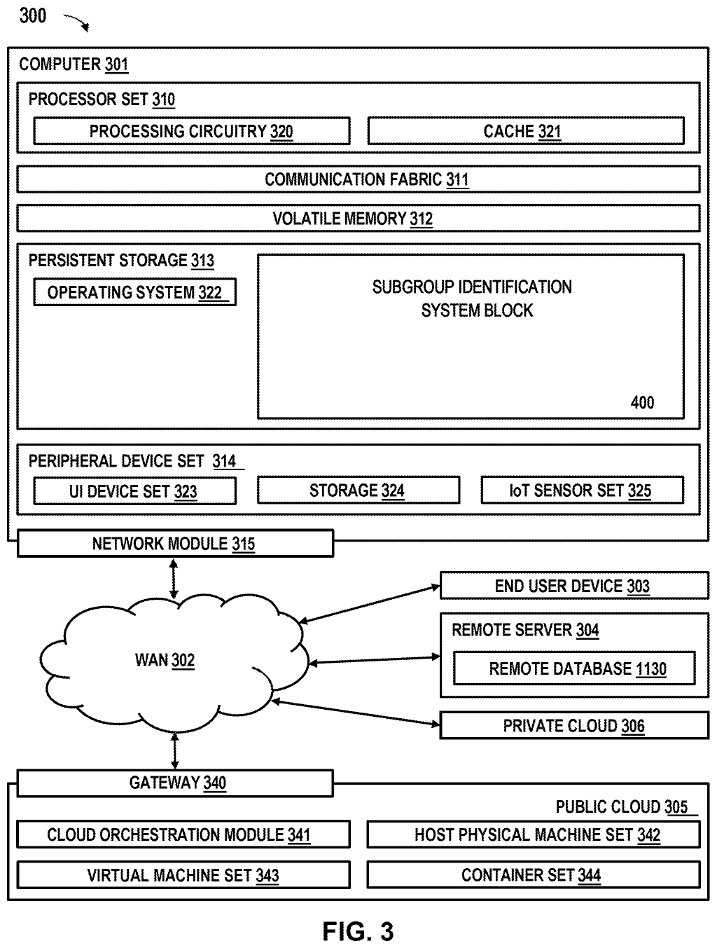

Referring to FIG. 3, computing environment 300 includes an example of an environment for the execution of at least some of the computer code involved in performing the inventive methods, including a subgroup identification engine block 400. In addition to block 400, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 400, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 400 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 400 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for identifying relevant subgroups in a training dataset associated with a machine learning model, comprising:
receiving a classification dataset wherein subgroups are unlabeled;
for each data point in the classification dataset, using gradient space partitioning (GraSP) to identify a gradient representation of each data point by extracting an associated gradient of a logistic regression classification loss with respect to weights of a logistic regression;
clustering the gradient representations to provide estimated subgroup labels; and
outputting cluster assignments as the estimated subgroup labels.

2. The computer-implemented method of claim 1, further comprising using an outlier-robust clustering algorithm to perform the clustering of the gradient representations.

3. The computer-implemented method of claim 1, wherein classes are labeled in the classification dataset.

4. The computer-implemented method of claim 1, further comprising learning group annotations and identifying outliers of the classification dataset.

5. The computer-implemented method of claim 1, further comprising training a robust classifier using the estimated subgroup labels.

6. The computer-implemented method of claim 5, further comprising applying distributionally robust optimization (DRO) to train the robust classifier.

7. The computer-implemented method of claim 1, further comprising, in response to receiving the classification dataset, applying a non-robust neural network classifier, wherein a last layer representation of the non-robust neural network classifier is extracted as dimension-reduced features.

8. The computer-implemented method of claim 7, wherein the gradient space partitioning is performed on the last-layer representation.

9. A computer-implemented method for identifying relevant subgroups, in a presence of outliers, for training a classifier to be robust to the identified subgroups, comprising:
receiving a classification dataset wherein subgroups are unlabeled;
for each data point in the classification dataset, using gradient space partitioning (GraSP) to identify a gradient representation of each data point by extracting an associated gradient of a logistic regression classification loss with respect to weights of a logistic regression, wherein the GraSP further learns group annotations and identify outliers;
clustering the gradient representations to estimate subgroup labels, wherein clustering further comprises using an outlier-robust clustering algorithm to cluster the gradient representations;
outputting cluster assignments as the estimated subgroup labels; and
training a robust classifier using the estimated subgroup labels.

10. The computer-implemented method of claim 9, wherein classes are labeled in the classification dataset.

11. The computer-implemented method of claim 9, further comprising applying distributionally robust optimization (DRO) to train the robust classifier.

12. The computer-implemented method of claim 9, further comprising, in response to receiving the classification dataset, applying a non-robust neural network classifier, wherein a last layer representation of the non-robust neural network classifier is extracted as dimension-reduced features.

13. The computer-implemented method of claim 12, wherein the gradient space partitioning is performed on the last-layer representation.

14. A non-transitory computer readable storage medium tangibly embodying a computer readable program code having computer readable instructions that, when executed, causes a computer device to carry out a method of identifying relevant subgroups in a training dataset associated with a machine learning model, the method comprising:
receiving a classification dataset wherein subgroups are unlabeled;
for each data point in the classification dataset, using gradient space partitioning (GraSP) to identify a gradient representation of each data point by extracting an associated gradient of a logistic regression classification loss with respect to weights of a logistic regression;
clustering the gradient representations to provide estimated subgroup labels; and
outputting cluster assignments as the estimated subgroup labels.

15. The non-transitory computer readable storage medium of claim 14, the method further comprising using an outlier-robust clustering algorithm to perform the clustering of the gradient representations.

16. The non-transitory computer readable storage medium of claim 14, the method further comprising learning group annotations and identifying outliers of the classification dataset.

17. The non-transitory computer readable storage medium of claim 14, the method further comprising training a robust classifier using the estimated subgroup labels.

18. The non-transitory computer readable storage medium of claim 17, the method further comprising applying distributionally robust optimization (DRO) to train the robust classifier.

19. The non-transitory computer readable storage medium of claim 14, the method further comprising, in response to receiving the classification dataset, applying a non-robust neural network classifier, wherein a last layer representation of the non-robust neural network classifier is extracted as dimension-reduced features.

20. The non-transitory computer readable storage medium of claim 19, wherein the gradient space partitioning is performed on the last-layer representation.
